(19) United States
(12) Patent Application Publication
(10) Pub. No.: US 2026/0184967 A1
(43) Pub. Date: Jul. 2, 2026

(54) ORGANO-TITANATES AS ADHESION PROMOTER FOR ANTI-NOISE SHIM ON BRAKE PADS, ASSOCIATED BRAKE PAD AND METHOD

(71) Applicant: ITT Italia S.R.L., Milan (IT)

(72) Inventors: Valeria POLLIOTTO, Barge (IT); Paolo GALIMBERTI, Barge (IT)

(73) Assignee: ITT Italia S.R.L., Milan (IT)

(21) Appl. No.: 18/872,561

(22) PCT Filed: Jun. 15, 2023
(86) PCT No.: PCT/IB2023/056208

§ 371 Date: Dec. 6, 2024

(30) Foreign Application Priority Data
Jun. 17, 2022 (IT) 102022000012896

(51) Int. Cl. C09J 5/02; C09D 5/00; C09D 7/20; C09D 7/63; C09J 133/08; F16D 65/00; F16D 65/092

(52) U.S. Cl. CPC C09J 5/02; C09D 5/002; C09D 7/20; C09D 7/63; C09J 133/08; F16D 65/0006; F16D 65/092; C09J 2203/354; C09J 2400/166; F16D 2200/0004; F16D 2200/0034; F16D 2250/0069; F16D 2250/0084

(57) ABSTRACT

For promoting adhesion of an anti-noise shim (6) to a surface (7) of a metallic support (2) of a braking element (1) normally painted with an epoxy resin and by means of gluing the anti-noise shim (6) to the surface by means of an acrylic glue, the surface (7) is pre-treated by applying a primer onto the epoxy resin paint layer (9), the primer consisting in an organo-titanate (10) diluted in an organic solvent, preferably an alcoholic polar solvent; the organo-titanate (10) is preferably a tetra-alkoxy titanium (IV) represented by the general formula Ti(OR)₄.

### CROSS-REFERENCE TO RELATED APPLICATIONS

This Patent application claims priority from Italian Patent application Ser. No. 102022000012896 filed on Jun. 17, 2022, the entire disclosure of which is incorporated herein by reference.

### TECHNICAL FIELD

The present invention relates to the use of specifically selected primer compounds to promote adhesion between an anti-noise sheet element, known as “shim”, and a first face of a metallic support, which bears on a second face thereof, opposite the first face, a friction material block or pad, the metallic support forming with the friction material block and the shim a vehicle braking element, like brake shoes or brake pads, in particular brake pads.

The invention further relates to an associated method for anchoring in a secure and substantially permanent manner a covering flat element, in particular an anti-noise sheet element or shim, to a metallic surface of a support, in particular when the metallic surface is painted with an organic resin, e.g. an epoxy resin.

The present invention further relates also to an associated braking element for a vehicle provided with an anti-noise element or shim having improved adhesion.

### PRIOR ART

The braking elements generally used in modern vehicles consist in brake pads comprising a friction material block and a support therefor, the support consisting in a metallic plate delimited by a first and a second opposite faces.

The first face is generally provided with a sheet element or foil called “shim” which covers a large part, or the whole, first face, while the second face bears a friction material block bonded thereto, e.g. by gluing or other methods.

In use, a direct or indirect thrust is exerted against the first face for pressing the friction material block carried by the second face against an element to be braked, e.g. a vehicle brake disc.

Since during this operation noises and vibrations may be produced due to the thrust exerted against the metallic surface of the first face of the support, also known as “backplate”, the first face is provided with the anti-noise element called shim, which is designed with elastomeric properties in order to adsorb or at least reduce such noises and vibrations.

There is therefore the problem to ensure a secure attachment of the anti-noise shim to the first face of the support, in order to avoid accidental detachments in use.

Unfortunately, nowadays, the brake pads (both friction material block and metallic backplate) are to be coated with a protective paint, generally an epoxy resin, so that anchoring in a secure manner the shim to the coated (painted) metallic surface of the backplate may be problematic.

Generally, the anti-noise shims usually applied onto the backplate are bonded thereto using an acrylic resin as adhesive.

However, also due to the presence of the epoxy coating there may be a low adherence between the shim and the backplate, coated with the epoxy resin, with subsequent risk of detachment in use of the shim, due to the mechanical stresses to which it is normally subjected.

In fact, the reduced presence of polar groups on the metallic support surface makes its surface tension low and therefore the ability of the anti-noise shim acrylic adhesive to adhere thereto also low. The low interaction between the metallic surface and the adhesive leads to an easily detachment of the anti-noise element (shim) from the backplate.

To solve this problem, a flaming treatment of the surface designed to receive the anti-noise shim has been used up to now. This treatment is in fact known to be able to polarize the surface through the formation of functional groups such as —OH, —COOH.

However, it would be preferable to avoid this treatment because it is in some cases low performing (so it does not solve the problem of the risk of detachment of the shim) and is dangerous, troublesome and expensive to be carried out.

In order to avoid the aforementioned drawback, the backplate may be provided with mechanical attachment points for the anti-noise shim, as schematically illustrated in FIG. 1.

The backplate A is provided on its metallic surface S facing the shim SH with pins P provided integral in one piece with the backplate A and arranged within shallow recesses R created on the metallic surface S. The shim SH is as well provided with hollow bulged sections B which couple mechanically with the pins P.

It is clear, however, that such a solution is complex and expensive to be implemented.

### SUMMARY OF THE INVENTION

It is an object of the present invention to provide a method for anchoring a covering sheet element like an anti-noise shim to a surface of a metallic support for a braking element, like the backplate of a vehicle brake pad, free from the drawbacks of the prior art and in particular which is reliable and easy and inexpensive to be implemented.

It is a further object of the present invention to provide a braking element, in particular a brake pad, comprising a support for a friction material block and an anti-noise shim applied to the support on the side opposite the friction material block, wherein the shim is bonded to the support in a secure and simple manner.

According to the present invention a method for anchoring a covering sheet element like an anti-noise shim to a surface of a metallic support for a braking element, like the backplate of a vehicle brake pad, and the associated braking element, are therefore provided as defined in the appended claims.

The invention also relates to the use of specifically selected chemical compounds as primers for promoting the chemical adhesion of a covering sheet element, like an anti-noise shim, to a metallic surface of a support, in particular to the face of a metallic backplate of a brake pad opposite to the friction material block thereof.

According to embodiments of the present invention, a covering sheet element, preferably consisting in an anti-noise shim of any type known in the art, is anchored/bonded to a surface of a metallic support for a braking element, e.g. a backplate, by a method including gluing the covering sheet element to such a surface and the step of pre-treating the surface before the gluing step; wherein the step of pre-treating the surface consists in applying to it a primer compound consisting in an organo-titanate diluted in an organic solvent.

In preferred embodiments the organo-titanate is a tetra-alkoxy titanium (IV) represented by the general formula

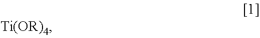

wherein R is all the same or different and may be chosen from the group consisting in: unsubstituted alchilic groups, either with single or branched chains; substituted alchilic groups, either with single or branched chains, wherein substituents are chosen in the group consisting in: amino, phosphilic, ether, unsaturated hydrocarbon groups.

In preferred embodiments the organic solvent is an alcoholic polar solvent.

The alcoholic polar solvent may be chosen from the group consisting in: isopropyl alcohol, ethanol, acetone, mixtures thereof.

In a most preferred embodiment the polar alcoholic solvent is isopropyl alcohol.

In embodiments of the method of the present disclosure the following steps are carried out on the surface of the metallic support designed to receive the covering sheet element, namely the anti-noise shim:
a) painting the surface with an epoxy resin;
b) applying on such surface already painted with the epoxy resin the organo-titanate in an organic solvent to form on the surface and above the epoxy resin an even layer of organo-titanate in solution;
c) gluing the covering sheet element to the surface already painted and pre-treated with the organo-titanate diluted in an organic solvent by applying between the covering sheet element and the even layer of organo-titanate in solution an acrylic glue or an adhesive based on an acrylic resin.

In preferred embodiments the covering sheet element consists in an anti-noise shim and the metallic support consists in a backplate of a vehicle brake pad, the aforementioned surface delimiting a first face of the backplate opposite to a second face thereof carrying a friction material block—

In preferred embodiments the organo-titanate is diluted in an alcoholic polar solvent with a dilution from 0.5% to 5% v/v (volume on volume).

In preferred embodiments the organo-titanate diluted in an organic solvent is applied to the aforementioned surface with a technique chosen in the group consisting in:
by spraying the organo-titanate solution,
by means of a roller coated with the organo-titanate solution,
by dropping unevenly the organo-titanate solution on the surface and then distributing it evenly by a cloth or a cloth covered applicator, e.g. a rotating disc.

Embodiments of the present invention consist in a braking element, in particular a brake pad, comprising a support for a friction material block and an anti-noise shim applied to the support on the side opposite the friction material block, wherein the shim is bonded to a first face of the support opposite to the friction material block; wherein:
i)—the first face of the support is painted with a first layer of an epoxy resin;
ii)—onto the first layer of epoxy resin is spread a second layer of an organo-titanate, the organo-titanate comprising alkoxy groups;
iii)—the shim is bonded to the first face by means of a third layer of an acrylic resin resting upon the second layer of organo-titanate;
iv)—wherein at least part of the respective alkoxy groups having been hydrolyzed by both the acrylic resin and the epoxy resin forming a chemical bond between the first and the third layer.

In preferred embodiments of the braking element according to the invention the organo-titanate forming the second layer is a tetra-alkoxy titanium (IV) represented by the general formula Ti(OR)₄, wherein R is all the same or different and is preferably chosen from the group consisting in: unsubstituted alchilic groups, either with single or branched chains; substituted alchilic groups, either with single or branched chains, wherein substituents are chosen in the group consisting in: amino, phosphilic, ether, unsaturated hydrocarbon groups.

Embodiments of the present invention consist in the use of a primer compound for promoting adhesion of an anti-noise sheet element or shim to a surface of a metallic support of a braking element, in particular a backplate of a vehicle brake pad, wherein:
the surface is painted with an epoxy resin,
the anti-noise shim is glued to said surface by means of an acrylic glue or an adhesive based on an acrylic resin,
the primer compound is spread onto the epoxy resin paint covering the surface so as to be interposed between the epoxy resin and the acrylic resin glue or adhesive,
the primer compound consists in an organo-titanate diluted in an organic solvent, preferably an alcoholic polar solvent,
the organo-titanate is a tetra-alkoxy titanium (IV) represented by the general formula Ti(OR)₄, wherein R is all the same or different and is preferably chosen from the group consisting in: unsubstituted alchilic groups, either with single or branched chains; substituted alchilic groups, either with single or branched chains, wherein substituents are chosen in the group consisting in: amino, phosphilic, ether, unsaturated hydrocarbon groups.

In preferred embodiment of the use according to the invention the organo-titanate is diluted in an alcoholic polar solvent with a dilution from 0.5% to 5% v/v, then is applied to the painted surface of the metallic support and is left to dry at room temperature.

### BRIEF DESCRIPTION OF DRAWINGS

Preferred but not limiting embodiments of the invention will be now described in more detail with reference to a number of practical working examples of implementation thereof which are solely intended to disclose in a non-exhaustive and not limiting manner the feature which are part of the content of the present disclosure, and with reference to the figures of the attached drawings, in which:

FIG. 1 shows in a schematic way a solution of the prior art to ensure a mechanical connection between an anti-noise shim and a corresponding mating face of a backplate for a brake pad, the whole brake pad being not shown for sake of simplicity;

FIG. 2 shows in an enlarged scale a schematic cross-section view of a metal support of a brake pad made according to the invention and provided with an anti-noise shim bonded to the support according to the method of the invention;

FIGS. 3 and 4 illustrate in a schematic manner the execution of two different tests for checking the efficacy of the bonding between a metal support and a known anti-noise shim;

FIGS. 5 and 6 show, respectively, a plan view and a cross-section view taken along a section plane VI-VI of a braking element, namely a brake pad, according to the present invention; and

FIG. 7 shows a simplified block diagram illustrating the sequence of steps of the method of the invention.

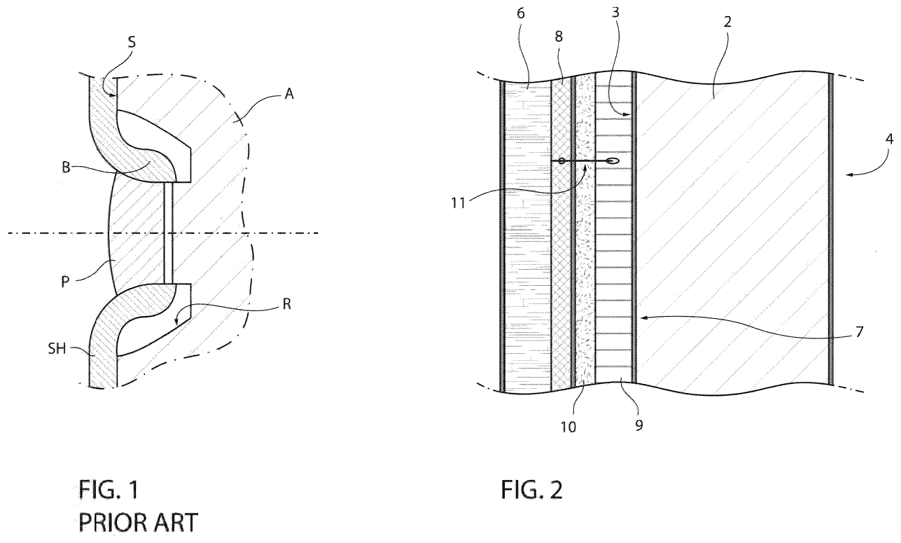

### DETAILED DESCRIPTION

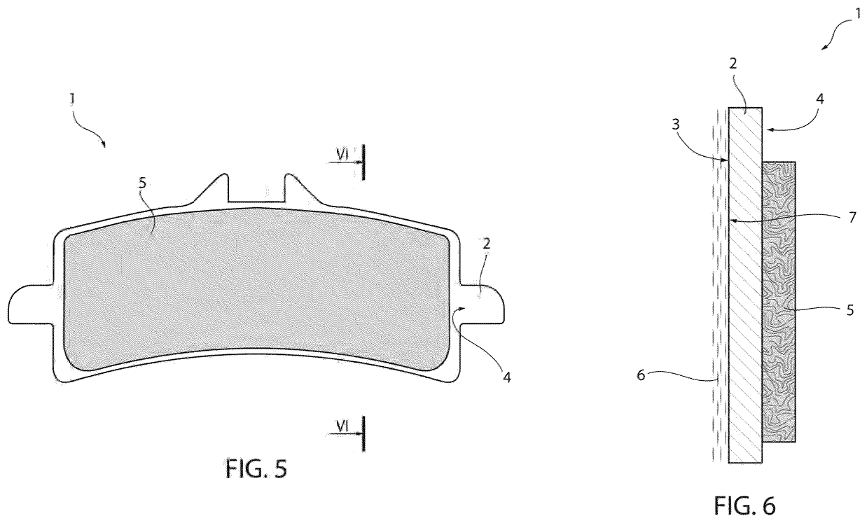

With reference to FIGS. 2, 5, 6 and 7, the reference number 1 indicates as a whole (FIG. 5) a braking element for a vehicle, in the non-limitative embodiment shown consisting in a brake pad of any shape, illustrated only schematically and out of scale, for exemplificative purposes only.

The braking element 1 comprises a metal support 2, also known as “backplate”, consisting of a flat metal plate delimited between two opposite, substantially planar, faces, namely a first face 3 and a second face 4, substantially parallel to face 3.

The braking element 1 further comprises a friction material block (or pad) 5, known in the art and bonded in any suitable manner to the second face 4, designed to face in use an element to be braked, e.g. a brake disc (not shown for sake of simplicity) and a well-known anti-noise element 6 carried by the first face 3 and covering the whole or at least part of the latter.

The anti-noise element 6, normally referred to as “shim”, is secured in a stable manner to face 3, so that the anti-noise shim 6 is applied to the support 2 on the side opposite the friction material block 5.

According to a first aspect of the invention, and with reference to FIG. 2, which represents in a fair enlarged scale the same cross-section of FIG. 6, but limited to backplate 2 and anti-noise shim 6, the anti-noise shim 6 is secured to a metallic surface 7 of the first face 3 by bonding, specifically by means of a layer 8 (FIG. 2) of known adhesive or glue, so that the shim 6 is bonded to the first face 3 of the support 2 opposite to the friction material block 5.

In a preferred embodiment of the invention the adhesive or glue forming the layer 8 is an acrylic adhesive or glue, e.g. of any commercial type.

In a preferred embodiment of the invention, the first face 3 of the support 2 is painted with a first layer 9 of synthetic paint (FIG. 2).

In a preferred embodiment, the layer 9 is formed by an epoxy resin paint, e.g. of any commercial type.

According to a main aspect of the invention, in order to promote secure adhesion between the anti-noise shim 6 and the metallic surface 7 of the first face 3 of the metallic support 2, onto the first layer of epoxy resin 9 is spread a second layer 10 of an organo-titanate.

According to an aspect of the invention, the organo-titanate 10 (i.e. forming the layer 10) comprises alkoxy groups.

In this manner, the anti-noise shim 6 is bonded to the first face 3 by means of a third layer 8 of an acrylic resin resting upon the second layer 10 of organo-titanate, which, in the preferred embodiment shown, rests upon the epoxy resin layer 9 of synthetic paint.

This specifically selected sequence of specifically selected materials surprisingly may avoid, as has been experimentally ascertained by the technical people of the Applicant, the accidental detachment in use of the anti-noise shim 6 from the backplate 2, since the organo-titanate forming the layer 10 work as a primer promoting adhesion.

In fact, at least part of the respective alkoxy groups of the organo-titanate 10 may be hydrolyzed by both the acrylic resin 8 and the epoxy resin 9, forming a chemical bond 11 (FIG. 2) between the first layer 9 and the third layer 8.

It is to be noted that the presence of the epoxy resin layer 9 may not be strictly necessary, even if strongly preferred.

According to preferred embodiments of the invention, the organo-titanate 10 forming the second layer is a tetra-alkoxy titanium (IV) represented by the general formula:

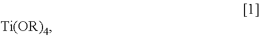

wherein R is all the same or different, on the basis of the surface chemistry of the subtracts 8, 9.
R usually are alchilic group, with single or branched chain, but can also have amino, phosphilic, ether or unsaturation parts.

Accordingly, R in formula [1] are preferably chosen from the group consisting in:
unsubstituted alchilic groups, either with single or branched chains;
substituted alchilic groups, either with single or branched chains,
wherein substituents are chosen in the group consisting in: amino, phosphilic, ether, unsaturated hydrocarbon groups.

Preferred but not limiting examples of organo-titanates suitable to act as primers according to the invention are chosen from commercially available organo-titanates, usually employed for completely different purpose (e.g. as catalyst):
Tyzor® TnBT—Tetra-n-butyl titanate

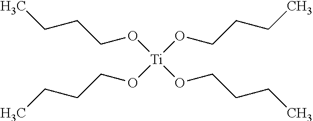

Tyzor® BTP—a polymeric butyl titanate
Tyzor® TPT—(tetra-isopropyl titanate)

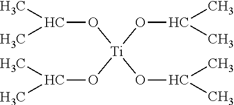

Tyzor® TOT—tetra-2-ethylhexyl titanate

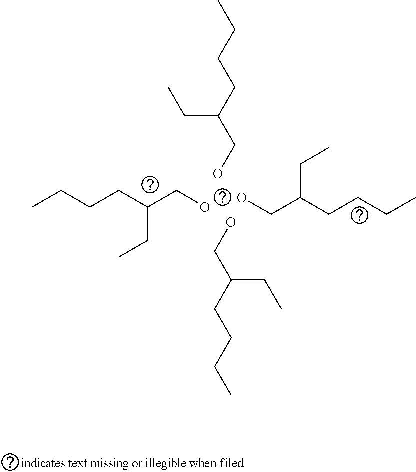

Tyzor® TE—triethanolamine titanate

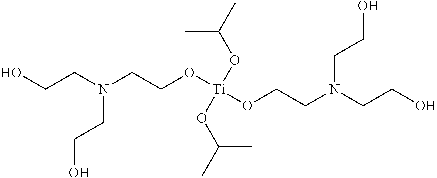

Ken-React® KR® 44—Isopropyl, tri (N-ethylenediamino)ethyl titanate

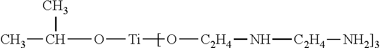

Ken-React® KR® TTS—Isopropyl, triisostearoyl titanate

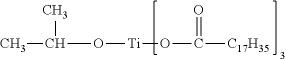

Ken-React® KR® 138S—Titanium di(dioctylpyrophosphate) oxyacetate

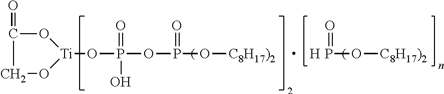

Ken-React® KR® 55—Tetra (2,2 diallyloxymethyl)butyl, di(ditridecyl)-phosphito titanate

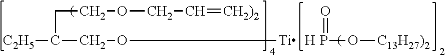

On the basis of what described above, it is evident that the present invention also extends to a method for anchoring a (any) covering sheet element 6, in the case in point an anti-noise shim, to a surface 7 of a metallic support 2 for a braking element 1 by gluing the covering sheet element 6 to such surface 7, comprising the step of pre-treating such surface 7 before the gluing step; wherein:
i. the step of pre-treating such surface 7 consists in applying to surface 7 a primer compound;
ii. the primer compound consists in an organo-titanate 10 diluted for easier application in an organic solvent.

The organo-titanate is a tetra-alkoxy titanium (IV) represented by the general formula [1] referred to above, wherein R is all the same or different and represented by one of the alchilic groups referred to above.

In preferred embodiments, the organic solvent is an alcoholic polar solvent.

In preferred embodiments, the alcoholic polar solvent is chosen from the group consisting in: isopropyl alcohol, ethanol, acetone, mixtures thereof.

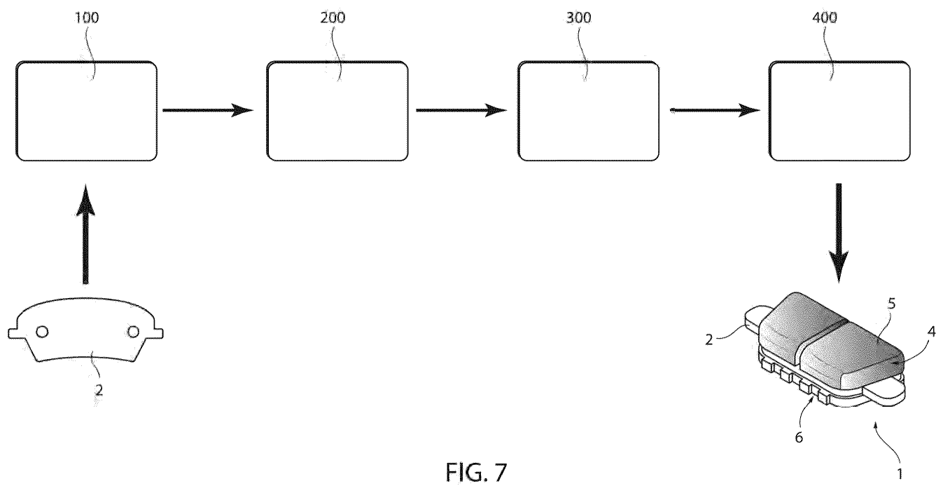

With reference to FIG. 7, the method of the invention preferably comprises the steps as follows:
a) a first step 100 of painting the surface 7 with an epoxy resin 9;
b) a second step 200 of applying on the surface 7 already painted with the epoxy resin 9 a selected organo-titanate diluted in an organic solvent to form on the surface 7 and above the epoxy resin 9 an even layer 10 of organo-titanate in solution, then leaving the layer 10 to dry;
c) a third step 300 of gluing the covering sheet element 6 to the surface 7 already painted and pre-treated with the organo-titanate 10 diluted in an organic solvent by applying between the covering sheet element 6 and the even layer 10 of organo-titanate an acrylic glue or an adhesive 8 based on an acrylic resin.

The organo-titanate 10 may be diluted in an alcoholic polar solvent with a dilution from 0.5% to 5% v/v.

The organo-titanate 10 diluted in an organic solvent may be applied to the surface 7 with a technique chosen in the group consisting in:
by spraying the organo-titanate 10 solution,
by means of a roller (known and not shown for sake of simplicity) coated with the organo-titanate 10 solution,
by dropping unevenly the organo-titanate 10 solution on the surface 7 and then distributing it evenly by a cloth or a cloth covered applicator of any type, e.g. a rotating disc.

It is also evident that the present invention extents to a method for producing a braking element 1 including a support 2, a friction material block 5 bonded to the support 2 and an anti-noise element 6 also bonded to the support 2 on the side opposite to the friction material block 5, comprising all the steps 100-300 as described above plus a step 400 (FIG. 7) of molding onto the support 2 the friction material block 5.

Of course, the step 400, though being represented in FIG. 7 in a sequence following the step 300 for illustrative purposes only, is normally carried out before the step 100, i.e. upstream step 100, so that also the friction material block 5 is totally or partially painted by the epoxy resin 9. Steps 100-300 are on the contrary carried out in the same sequence as illustrate in FIG. 7.

It finally clear that the present invention also extends to the use of a primer compound for promoting adhesion of an anti-noise sheet element or shim 6 to a surface 7 of a metallic support 2 of a braking element 1, in the preferred embodiment shown a backplate 2 of a vehicle brake pad 1, wherein:
the surface 7 may be painted with an epoxy resin 9,
the anti-noise shim 6 may be glued to the surface 7 by means of an acrylic glue 8 or an adhesive 8 based on an acrylic resin,
the primer compound is spread onto the epoxy resin paint 9 covering the surface 7 so as to be interposed between the epoxy resin 9 and the acrylic resin glue or adhesive 8;
the primer compound consists in an organo-titanate 10 diluted in an organic solvent, preferably an alcoholic polar solvent which may be spread to form an even layer 10;
the organo-titanate is a tetra-alkoxy titanium (IV) represented by the general formula Ti(OR)₄, wherein R is as defined previously.

In a preferred embodiment of the use according to the invention, the organo-titanate is diluted in an alcoholic polar solvent with a dilution from 0.5% to 5% v/v, then is applied to the surface 7 and is left to dry at room temperature before gluing the shim 6.

The present invention will be now further described with reference to the following practical working examples which also made a clear evidence of its efficacy, demonstrating that the invention effectively works.

### Example 1

An organo-titanate consisting in Tetra-n-butyl titanate is diluted in isopropyl alcohol, with a dilution of 1% v/v ad applied on a surface of a commercial backplate designed to receive in use an anti-noise shim.

The backplate is painted with a commercial epoxy resin paint.

The organo-titanate is applied pouring four drops of the organo-titanate alcoholic solution on the interested surface and then spread onto the whole surface manually with a cloth.

The applied organo-titanate alcoholic solution is left to dry at room temperature for few (less than ten) seconds.

Thereafter, a commercial anti-noise shim, pre-glued with a commercial acrylic adhesive, is applied to the organo-titanate treated surface on the side of its pre-glued face for a pressing time of 1-5 second and with a pressing force comprised between 1000 and 2000 Kg.

Thereafter, adherence has been measured by lap shear strength and pull-off tests, comparing the results with the same tests applied to an identical backplate which has received an identical pre-glued shim but without the pre-treatment of the receiving surface of the backplate with the organo-titanate.

### Example 2—Pull-Off Test

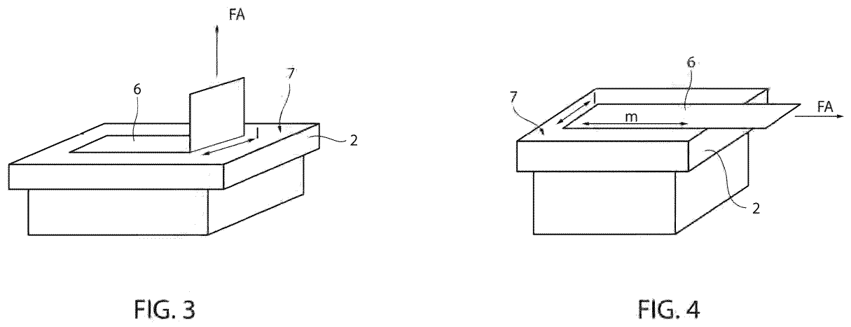

The test is carried out as shown in FIG. 3. The shim 6 has been attached on the surface 7 of backplates 2 both bare (surface 7 without an organo-titanate layer 10) and pretreated with the organo-titanate primer 10. After 24 hours a part of the shim 6 has been folded at 90° as shown in FIG. 3.

The adherence of the shim 6 on the backplate 2 (pre-treated and not) is measured pulling the anti-noise shim 6 in a direction perpendicular to the surface 7 of the backplate 2 with a force F_{A}. The resulting forces are calculated in N/mm with the following formula:

$$pA = {F}_{A} / l \qquad [ 2 ]$$

where pA is the pull-off force and 1 is the width of the shim 6.

The results are reported in the following Table 1.

TABLE 1

| | NO PRIMER | WITH PRIMER |
|---|---|---|
| 1 | 1.37 | 4.93 |
| 2 | 1.48 | 5.75 |
| 3 | 1.41 | 6.23 |
| 4 | 0.98 | 4.95 |
| 5 | 1.30 | 5.35 |
| 6 | 1.35 | 5.15 |

### Example 3—Lap Shear Test

The test is carried out as shown in FIG. 4. The shim 6 has been attached on the surface 7 of back-plates 2 both bare (surface 7 without an organo-titanate layer 10) and pretreated with the organo-titanate primer 10, as in Example 2. After 24 hours, the anti-noise shim 6 is subjected to a shearing stress pA by applying an axially force F_{A} to the backplate 2 in a direction parallel to the surface 7. The resulting forces are calculated in N/cm² with the following formula:

$$p A = {F}_{A} / l * m \qquad [ 3 ]$$

where pA is the Lap-shear force, 1 is the width of the shim 6 and m is the length of shim 6 glued to the backplate.

The results are reported in the following Table 2.

TABLE 2

| | NO PRIMER | WITH PRIMER |
|---|---|---|
| 1 | 22.33 | 100.56 |
| 2 | 28.37 | 121.32 |
| 3 | 22.96 | 126.09 |
| 4 | 28.11 | 114.16 |
| 5 | 33.17 | 120.84 |

### Example 4—T-PULL Test Vs. Amount of Primer

The shim 6 has been attached on a backplate surface 7 pretreated with an organo-titanate primer consisting in a commercial Tetra-n-butyl titanate (Tyzor-TnBT) at different concentration in isopropyl alcohol: 0.5%, 1%, 5% and 10 v/v. After 24 hours a part of the shim 6 has been folded at 90°.

The adherence of the shim 6 on the backplate 2 is measured pulling the anti-noise shim 6 in a perpendicular direction to the backplate surface 7, as described in Example 2. The resulting forces are calculated with formula [2] and reported in the following Table 3.

TABLE 3

| | NO | 0.5% | 1% | 5% | 10% |
|---|---|---|---|---|---|
| | PRIMER | primer | primer | primer | primer |
| | N/mm | N/mm | N/mm | N/mm | N/mm |
| 1 | 1.37 | 3.33 | 4.93 | 4.37 | 2.21 |
| 2 | 1.48 | 2.7 | 5.75 | 4.45 | 2.27 |
| 3 | 1.41 | 2.23 | 6.23 | 4.46 | 3.45 |
| 4 | 0.98 | 1.69 | 4.95 | 2.63 | 2.74 |
| 5 | 1.30 | 2.35 | 5.35 | 2.62 | 1.89 |
| 6 | 1.35 | 3.19 | 5.15 | 3.08 | 2.23 |

It can be noticed that the use of organo-titanate primers increases the adhesion of the shim 6 in all concentrations. However, the best performance is reached at the concentration of 1%. Dilution of 0.5, 5 and 10% v/v indeed show applied forces lower than that obtained with primer diluted at 1% v/v.

### CONCLUSIONS

The use of the organo-titanate primers provides a chemical bridge between the sub-layer and the adhesive shim in such a way that the traditional flaming treatment of the epoxy paint can be eliminated.

Another advantage in using the method of the invention is the reduction of the risks and of the cost of the anti-noise shim application, because of the low amount required of organo-titanate.

The alkoxy groups of the selected organo-titanates have in fact shown to be easily hydrolyzed by some groups present on the surface of the epoxy and acrylic resins. In that way, the connection sites between the two resins are increased and thus a hard-wearing bridge between them is formed.

The advantages of this solution are:
1) To avoid the flaming treatment.
2) Increasing of the adherence of the shim in time through chemical bond with both epoxy resin of the backplate and the acrylic resin of the anti-noise shim.
3) Reduction of the risks and the cost of the anti-noise shim application.

All the aims of the present disclosure are therefore fulfilled.

### Certain Terminology

Although certain braking devices, systems, and methods have been disclosed in the context of certain example embodiments, it will be understood by those skilled in the art that the scope of this disclosure extends beyond the specifically disclosed embodiments to other alternative embodiments and/or uses of the embodiments and certain modifications and equivalents thereof, like brake shows for braking systems based on brake drums. Use with any structure is expressly within the scope of this invention. Various features and aspects of the disclosed embodiments can be combined with or substituted for one another in order to form varying modes of the assembly. The scope of this disclosure should not be limited by the particular disclosed embodiments described herein.

Conditional language, such as “can,” “could,” “might,” or “may,” unless specifically stated otherwise, or otherwise understood within the context as used, is generally intended to convey that certain embodiments include or do not include, certain features, elements, and/or steps. Thus, such conditional language is not generally intended to imply that features, elements, and/or steps are in any way required for one or more embodiments.

Unless stated otherwise, the terms “approximately,” “about,” and “substantially” as used herein represent an amount close to the stated amount that still performs a desired function or achieves a desired result. For example, in some embodiments, as the context may dictate, the terms “approximately”, “about”, and “substantially” may refer to an amount that is within less than or equal to 10% of the stated amount. Likewise, the term “generally” as used herein represents a value, amount, or characteristic that predominantly includes or tends toward a particular value, amount, or characteristic.

This disclosure expressly contemplates that various features and aspects of the disclosed embodiments can be combined with, or substituted for, one another. Accordingly, the scope of this disclosure should not be limited by the particular disclosed embodiments described above, but should be determined only by a fair reading of the claims that follow as well as their full scope of equivalents.

1. A method for anchoring a covering sheet element (6) to a surface (7) of a metallic support (2) for a braking element (1) by gluing the covering sheet element to said surface, comprising:
pre-treating said surface (7) before the gluing by applying to said surface a primer compound, wherein the primer compound consists of an organo-titanate (10) diluted in an organic solvent.

2. The method of claim 1, wherein
the organo-titanate (10) is a tetra-alkoxy titanium (IV) represented by the general formula Ti(OR)4,
R is all the same or different and is preferably chosen from the group consisting of: unsubstituted alchilic groups, either with single or branched chains; substituted alchilic groups, either with single or branched chains, and
substituents are chosen in the group consisting of: amino, phosphilic, ether, unsaturated hydrocarbon groups.

3. The method of claim 1 wherein the organic solvent is an alcoholic polar solvent.

4. The method of claim 3, wherein the alcoholic polar solvent is chosen from the group consisting of: isopropyl alcohol, ethanol, acetone, mixtures thereof.

5. The method according to claim 1, further comprising:
painting (100) said surface with an epoxy resin (9);
applying (200) on said surface (7) already painted with the epoxy resin (9) said organo-titanate (10) in an organic solvent to form on said surface and above said epoxy resin an even layer of organo-titanate (10) in solution;
gluing (300) said covering sheet element (6) to said surface (7) already painted and pre-treated with said organo-titanate (10) diluted in an organic solvent by applying between the covering sheet element (6) and said even layer of organo-titanate (10) in solution an acrylic glue or an adhesive based on an acrylic resin (8).

6. The method according to claim 1, wherein said covering sheet element consists of an anti-noise shim (6) and in that the said metallic support consists in a backplate (2) of a vehicle brake pad (1), said surface (7) delimiting a first face (3) of the backplate (2) opposite to a second face (4) thereof carrying a friction material block (5); said organo-titanate (10) being diluted in an alcoholic polar solvent with a dilution from 0.5% to 5% v/v.

7. The method according to claim 1, wherein said organo-titanate (10) diluted in an organic solvent is applied to said surface (7) with a technique chosen in the group consisting of:
spraying the organo-titanate solution,
means of a roller coated with the organo-titanate solution,
dropping unevenly the organo-titanate solution on said surface and then distributing it evenly by a cloth or a cloth covered applicator.

8. A braking element (1), in particular a brake pad, comprising:
a support (2) for a friction material block (5); and
an anti-noise shim (6) applied to the support on the side opposite the friction material block, wherein
the shim (6) is bonded to a first face (3) of the support opposite to said friction material block;
said first face (3) of the support is painted with a first layer of an epoxy resin (9);
a second layer of an organo-titanate (10) is spread onto said first layer of epoxy resin (9),
the organo-titanate comprising alkoxy groups;
the shim (6) is bonded to said first face (3) by means of a third layer of an acrylic resin (8) resting upon the second layer of organo-titanate (10);
at least part of the respective alkoxy groups having been hydrolyzed by both the acrylic resin and the epoxy resin (9, 8) form a chemical bond (11) between the first and the third layer.

9. The braking element of claim 8, wherein the organo-titanate (10) forming the second layer is a tetra-alkoxy titanium (IV) represented by the general formula Ti(OR)4, wherein R is all the same or different and is preferably chosen from the group consisting of: unsubstituted alchilic groups, either with single or branched chains; substituted alchilic groups, either with single or branched chains, and wherein substituents are chosen in the group consisting of: amino, phosphilic, ether, unsaturated hydrocarbon groups.

10. (canceled)

11. (canceled)

12. (canceled)

13. A vehicle brake pad, comprising:
a shim;
a metallic backplate;
an anti-noise sheet element; and
a primer compound for promoting adhesion of the anti-noise sheet element to the metallic backplate, wherein
a surface of the shim is painted with an epoxy resin,
the anti-noise shim is glued to the surface of the shim by means of an acrylic glue or an adhesive based on an acrylic resin,
the primer compound is spread onto the epoxy resin paint layer covering the surface of the shim so as to be interposed between the epoxy resin and the acrylic resin glue or adhesive;
the primer compound consists of an organo-titanate diluted in an organic solvent,
the organo-titanate is a tetra-alkoxy titanium represented by the general formula Ti(OR)4, wherein R is all the same or different and is preferably chosen from the group consisting in: unsubstituted alchilic groups, either with single or branched chains, substituted alchilic groups, either with single or branched chains, and substituents are chosen in the group consisting of: amino, phosphilic, ether, unsaturated hydrocarbon groups.

14. The vehicle brake pad according to claim 13, wherein the organic solvent is an alcoholic polar solvent.

15. The vehicle brake pad according to claim 14, wherein the organo-titanate is diluted in the alcoholic polar solvent with a dilution from 0.5% to 5% v/v, then is applied to the surface of the shim and is left to dry at room temperature.

16. A method for producing a braking element including a support, a friction material block bonded to the support and an anti-noise element also bonded to the support on the side opposite to the friction material block, comprising:
gluing the anti-noise element to a surface of the support;
pre-treating the surface before the gluing by applying to the surface a primer compound, wherein the primer compound consists of an organo-titanate diluted in an organic solvent; and
molding the friction material block onto the support.

17. The method of claim 16, wherein
the organo-titanate is a tetra-alkoxy titanium (IV) represented by the general formula Ti(OR)4,
R is all the same or different and is preferably chosen from the group consisting of: unsubstituted alchilic groups, either with single or branched chains; substituted alchilic groups, either with single or branched chains, and
substituents are chosen in the group consisting of: amino, phosphilic, ether, unsaturated hydrocarbon groups.

18. The method of claim 16, wherein the organic solvent is an alcoholic polar solvent chosen from the group consisting of: isopropyl alcohol, ethanol, acetone, mixtures thereof.

19. The method according to claim 16, further comprising:
painting the surface with an epoxy resin;
applying on the surface already painted with the epoxy resin the organo-titanate in an organic solvent to form on the surface and above the epoxy resin an even layer of organo-titanate in solution;
gluing the anti-noise element to the surface already painted and pre-treated with the organo-titanate diluted in an organic solvent by applying between the anti-noise element and the even layer of organo-titanate in solution an acrylic glue or an adhesive based on an acrylic resin.

20. The method according to claim 16, wherein the anti-noise element consists of an anti-noise shim and in that the support consists in a backplate of a vehicle brake pad, the surface delimiting a first face of the backplate opposite to a second face thereof carrying a friction material block, the organo-titanate being diluted in an alcoholic polar solvent with a dilution from 0.5% to 5% v/v.

21. The method according to claim 16, wherein the organo-titanate diluted in an organic solvent is applied to the surface with a technique chosen in the group consisting of:
spraying the organo-titanate solution,
means of a roller coated with the organo-titanate solution,
dropping unevenly the organo-titanate solution on the surface and then distributing it evenly by a cloth or a cloth covered applicator.
